(19) United States
(12) Patent Application Publication
(10) Pub. No.: US 2020/0171850 A1
(43) Pub. Date: Jun. 4, 2020

(54) PRINTER FOR REPOSITIONABLE NOTE

(71) Applicant: MANGOSLAB CO., LTD., Seongnam-si (KR)

(72) Inventors: Yong Soo JEONG, Suwon-si Gyeonggi-do (KR); Yong Shik PARK, Yongin-si (KR)

(73) Assignee: MANGOSLAB CO., LTD., Seongnam-si (KR)

(21) Appl. No.: 16/781,087

(22) Filed: Feb. 4, 2020

Related U.S. Application Data
(62) Division of application No. 15/683,206, filed on Aug. 22, 2017.

(30) Foreign Application Priority Data
Nov. 16, 2016 (KR) 10-2016-0152569
Nov. 16, 2016 (KR) 10-2016-0152570

(51) Int. Cl. B41J 11/00; B41J 15/04; B41J 3/407; B41J 13/02; B41J 2/32; B41J 29/02

(52) U.S. Cl. CPC B41J 11/0005; B41J 15/042; B41J 29/02; B41J 13/02; B41J 2/32; B41J 3/4075

(57) ABSTRACT

The present disclosure relates to a printer for repositionable note, including: a housing including an accommodation unit configured to accommodate a repositionable note wound in the form of a roll with at least one adhesive portion exposed and an ejection outlet through which the note withdrawn from the accommodation unit is ejected, and forming a movement path for the note from the accommodation unit to the ejection outlet; a print unit including a thermal head provided on the movement path and configured to print on the note ejected through the ejection outlet and a feed roller configured to rotate in a direction opposite to a rotation direction of the note when the note accommodated in the housing is withdrawn and provided to face the thermal head and thus to enable printing on the note while transferring the note.

### CROSS-REFERENCE TO RELATED APPLICATIONS

This application is a divisional application of U.S. patent application Ser. No. 15/683,206 filed on Aug. 22, 2017, which claims the benefit under 35 USC 119(a) of Korean Patent Application No. 10-2016-0152569 filed on Nov. 16, 2016 and Korean Patent Application No. 10-2016-0152570 filed on Nov. 16, 2016, in the Korean Intellectual Property Office, the entire disclosures of which are incorporated herein by reference for all purposes.

### TECHNICAL FIELD

The present disclosure relates to a printer for repositionable note and more particularly, to a printer for repositionable note capable of printing on a repositionable note wound in the form of a roll with an adhesive portion exposed.

### BACKGROUND

Repositionable notes that have adhesive properties and can be repeatedly attached and detached have been used in everyday life and in study or business to note important information.

Conventionally, users have used adhesive notes to handwrite what they want thereon. In this case, it has been difficult to write on the adhesive notes contents unsuitable for handwriting such as images, tables, graphs, symbols, figures, and photos.

Meanwhile, a printer is configured to print images on a note through a printhead. Printers can be classified into various types such as dot type, inkjet type, laser type, thermal transfer type, thermal sensitive type, and the like depending on printing method.

A thermal sensitive printer includes a thermal head configured to selectively make multiple heating elements generate heat and performs printing by applying heat with the thermal head in direct contact with a thermal sensitive note.

The thermal sensitive printer uses thermal paper only as a note instead of plain paper, but does not require ink, a toner, and the like. Also, the thermal sensitive printer can be miniaturized and thus is portable due to its simple printing principle, and is not expensive.

However, printing paper for the thermal sensitive printer is wound in the form of a roll and thus may be curled when ejected from the printer.

Thus, when a note is printed through the thermal head, the print quality may deteriorate and the printed note may not be readily ejected through an ejection outlet of the printer and may be easily jammed. Further, one end of the printed note is rolled, and, thus, the printed note cannot be kept neatly. Accordingly, the present inventors have developed a printer for repositionable note capable of printing on a repositionable note with an adhesive portion and reducing curls on the note and thus improving the print quality.

### SUMMARY

In view of the foregoing, an exemplary embodiment of the present disclosure provides a printer for repositionable note capable of printing on a repositionable note wound in the form of a roll and suppressing contamination of a print unit by an adhesive portion of the node when printing the note and also suppressing a malfunction occurring when the note adheres so as not to be moved.

Further, an exemplary embodiment of the present disclosure provides a printer for repositionable note capable of easily distinguishing an accommodation direction of a note and suppressing incorrect accommodation of the note.

According to an aspect of the present disclosure, a printer for repositionable note includes: a housing including an accommodation unit configured to accommodate a repositionable note wound in the form of a roll with at least one adhesive portion exposed and an ejection outlet through which the note withdrawn from the accommodation unit is ejected, and forming a movement path for the note from the accommodation unit to the ejection outlet; and a print unit including a thermal head provided on the movement path and configured to print on the note ejected through the ejection outlet and a feed roller configured to rotate in a direction opposite to a rotation direction of the note when the note accommodated in the housing is withdrawn and provided to face the thermal head and thus to enable printing on the note while transferring the note; and a decurling unit configured to guide the withdrawal of the note in order for a withdrawal path between the accommodation unit and the ejection outlet to be curved.

Herein, the printer for repositionable note may include a decurling unit provided on the movement path and including a step or a rollable device at a position corresponding to a movement path of the adhesive portion of the note and configured to guide the note to be curved in a direction opposite to a winding direction of the note.

Further, the print unit may include a fixed part with a step on an upper end of the feed roller.

Both ends of a paper roller wound around with the note in the form of a roll may have different outer diameters from each other, the accommodation unit may include a first mounting groove and a second mounting groove having inner diameters corresponding to the both ends of the paper roller having different outer diameters from each other, and the paper roller having different outer diameters may be rotatably mounted in the first mounting groove and the second mounting groove.

A rotation central axis for the note in the accommodation unit may be positioned higher than a central axis of the decurling unit with respect to the bottom of the housing.

The printer for repositionable note may further include a droop suppressing guide provided on the movement path and configured to suppress the droop of the note moving along the movement path.

A front end of the droop suppressing guide where the note is slidably moved may be positioned equal to or higher than the rotation central axis for the note with respect to the bottom of the housing.

The droop suppressing guide may form a part of the movement path for the note and may be curved to partially surround the decurling unit.

The printer for repositionable note may further include a cartridge case detachably attached to the accommodation unit and configured to accommodate the note and fix a position of the center of the note.

The cartridge case may include: a note accommodation part configured to accommodate the note; a note holder on which the note is rotatably mounted; and a withdrawal opening configured to supply the note accommodated in the note accommodation part to the print unit.

The note accommodation part of the cartridge case may include a step within an inner surface of the accommodation unit, and a thinner portion thereof may be positioned corresponding to the adhesive portion of the note and a thicker portion thereof may be positioned corresponding to a non-adhesive portion of the note.

The accommodation unit of the housing may include a step not to be in contact with the adhesive portion of the repositionable note wound in the form of a roll at a position corresponding to the adhesive portion.

The printer for repositionable note may further include a note basket accommodated in the accommodation unit of the housing and configured to accommodate the repositionable note wound in the form of a roll, and the note basket may include a step not to be in contact with the adhesive portion of the repositionable note at a position corresponding to the adhesive portion.

Both ends of a paper roller wound around with the note in the form of a roll may be protruded to different lengths from each other.

Both ends of a paper roller wound around with the note in the form of a roll may have different inner diameters from each other.

The cartridge case may include a step having a different outer diameter, and accordingly, the accommodation unit of the housing may include a step having a different inner diameter.

The cartridge case may be formed asymmetrically in a front to back direction or in an up and down direction, and accordingly, the accommodation unit of the housing may be formed asymmetrically.

The printer for repositionable note may further include: a protrusion which is protruded from any one of an outer surface of the cartridge case and an inner surface of the accommodation unit of the housing; and an insertion groove which is dented in the other of the outer surface of the cartridge case and the inner surface of the accommodation unit of the housing and into which the protrusion is inserted and combined.

The accommodation unit of the housing may include a step not to be in contact with the adhesive portion of the repositionable note wound in the form of a roll at a position corresponding to the adhesive portion.

According to another aspect of the present disclosure, a printer for repositionable note includes: a housing including an accommodation unit configured to accommodate a repositionable note wound in the form of a roll with at least one adhesive portion exposed and an ejection outlet through which the note withdrawn from the accommodation unit is ejected, and forming a movement path for the note from the accommodation unit to the ejection outlet; a print unit including a thermal head provided on the movement path and configured to print on the note ejected through the ejection outlet and a feed roller including a step at a position corresponding to a movement path of the adhesive portion of the note or configured to rotate a rollable device in a direction opposite to a rotation direction of the note in which the note accommodated in the housing is unwound and transfer the note while applying pressure to the thermal head; a decurling unit provided on the movement path and including a step or a rollable device at a position corresponding to a movement path of the adhesive portion of the note and configured to guide the note to be curved in a direction opposite to a winding direction of the note; and a droop suppressing guide provided on the movement path and configured to suppress the droop of the note moving along the movement path, and a rotation central axis for the note in the accommodation unit may be positioned higher than a central axis of the decurling unit with respect to the bottom of the housing and a front end of the droop suppressing guide where the note is slidably moved may be positioned equal to or higher than the rotation central axis for the note with respect to the bottom of the housing.

According to any one of the aspects of the present disclosure, it is possible to print on a repositionable note wound in the form of a roll and reduce curls on the note with an adhesive portion and thus improve the print quality. Also, it is possible to readily eject the printed note and neatly keep the ejected note being attached. Further, it is possible to suppress contamination of a print unit by an adhesive portion of the node when printing the note and also possible to suppress a malfunction occurring when the note adheres so as not to be moved.

Furthermore, it is possible to easily distinguish an accommodation direction of the note and also possible to suppress incorrect accommodation of the note.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a perspective view of a printer for repositionable note in accordance with an exemplary embodiment of the present disclosure.

FIG. 2 is an exploded perspective view of main parts of FIG. 1.

FIG. 3 is a perspective view showing a state where an upper housing of FIG. 1 is removed.

FIG. 4 is an exploded perspective view of a housing and a cartridge case of FIG. 1.

FIG. 5 is an exploded perspective view as seen in a different direction from FIG. 4.

FIG. 6 is a perspective view showing a state where the note of FIG. 3 is mounted.

FIG. 7 is a side view of FIG. 6.

FIG. 8 is a diagram illustrating a path along which a repositionable note is printed by a printer for repositionable note in accordance with an exemplary embodiment of the present disclosure.

FIG. 9 is a diagram illustrating a path along which a repositionable note is printed by a printer for repositionable note as the note is consumed in accordance with an exemplary embodiment of the present disclosure.

FIG. 10 is a perspective view of a feed roller of FIG. 1.

FIG. 11 is a perspective view of a decurling unit of FIG. 1.

FIG. 12 is a perspective view of a cartridge case of FIG. 1,

FIG. 13 is a perspective view of a printer for repositionable note from which an upper housing is separated in accordance with another exemplary embodiment of the present disclosure.

FIG. 14 is a perspective view of a note applicable to a printer for repositionable note in accordance with the present disclosure.

FIG. 15 is a cross-sectional view of FIG. 1.

FIG. 16A illustrates a state where a note is combined with paper rollers of various shapes of FIG. 15.

FIG. 16B illustrates a state where a note is combined with paper rollers of various shapes of FIG. 15.

FIG. 17 is a schematic perspective view of an accommodation unit of a housing in accordance with another exemplary embodiment of the present disclosure.

FIG. 18 is a diagram illustrating a state where a repositionable note is accommodated in an accommodation unit of FIG. 17.

FIG. 19 is a diagram illustrating a state where a note basket is provided in an accommodation unit of a housing in accordance with yet another exemplary embodiment of the present disclosure.

FIG. 20 is a diagram illustrating a state where a repositionable note is accommodated in a note basket of FIG. 19.

### DETAILED DESCRIPTION

The advantages and features of the present disclosure, and methods for accomplishing the same will be more clearly understood from exemplary embodiments described below with reference to the accompanying drawings. However, the present disclosure is not limited to the following exemplary embodiments but may be implemented in various different forms. The exemplary embodiments are provided only to complete disclosure of the present disclosure and to fully provide those skilled in the art to which the present disclosure pertains with the category of the invention, and the present disclosure will be defined by the appended claims.

The terms used herein are provided only for illustration of the exemplary embodiments but not intended to limit the present disclosure. As used herein, the singular terms include the plural reference unless the context clearly indicates otherwise. The terms “comprises” and/or “comprising” specify the presence of stated components but do not preclude the presence or addition of one or more other components. Throughout the whole specification, the same reference numerals denote the same elements, and the term “and/or” includes any and all combinations of one or more of the stated components. Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Unless otherwise defined, all terms (including technical and scientific terms) used herein have the same meaning as commonly understood by those skilled in the art to which this invention belongs. It will be further understood that terms defined in commonly used dictionaries should not be interpreted in an idealized or overly formal sense unless expressly so defined herein.

Hereinafter, various exemplary embodiments of the present disclosure will be described in detail with reference to the accompanying drawings.

Prior to description, in several exemplary embodiments, a first exemplary embodiment is representatively described by using the same reference numerals for components having the same configuration, and for other exemplary embodiments, description will be given of different configuration from that of the first exemplary embodiment.

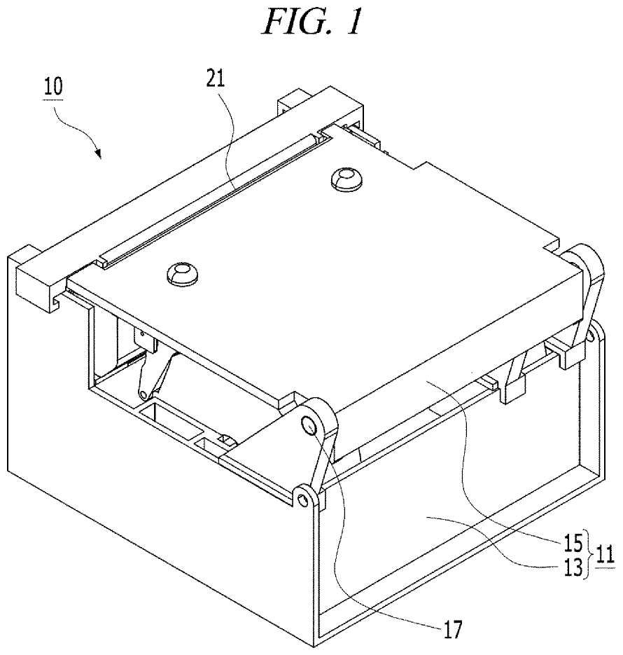

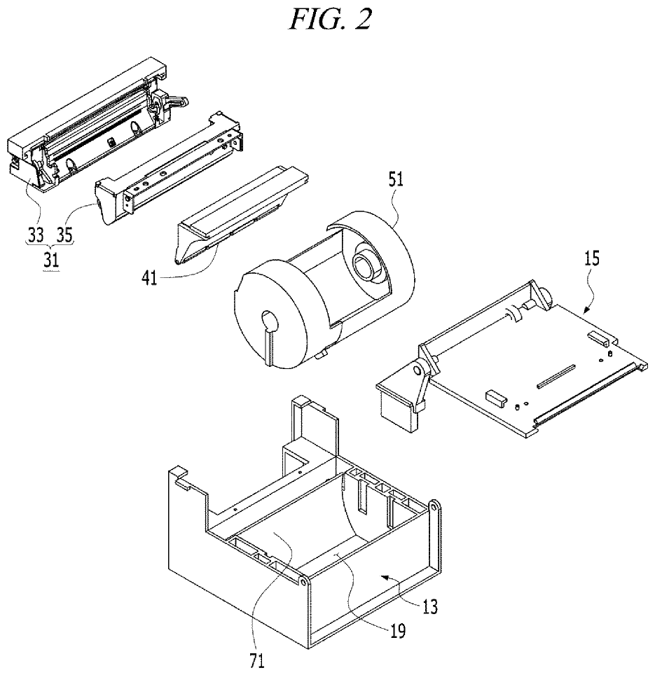

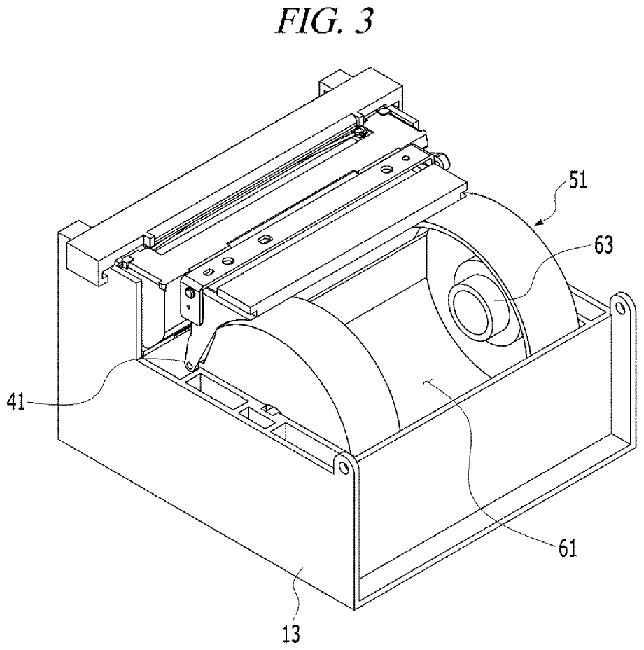

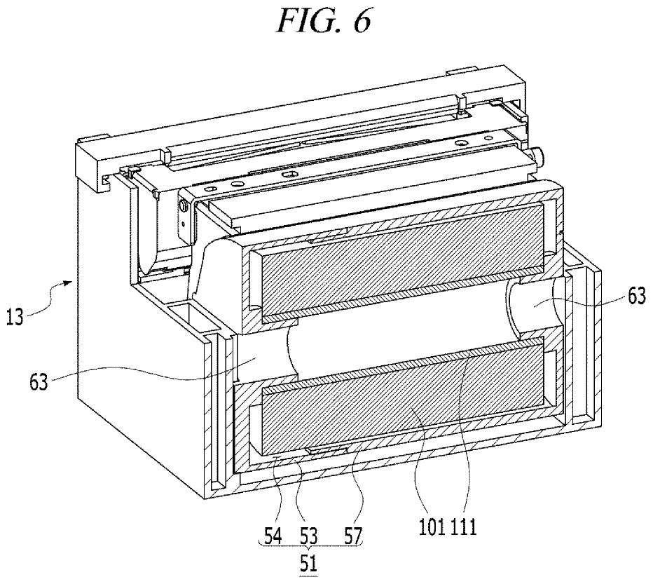

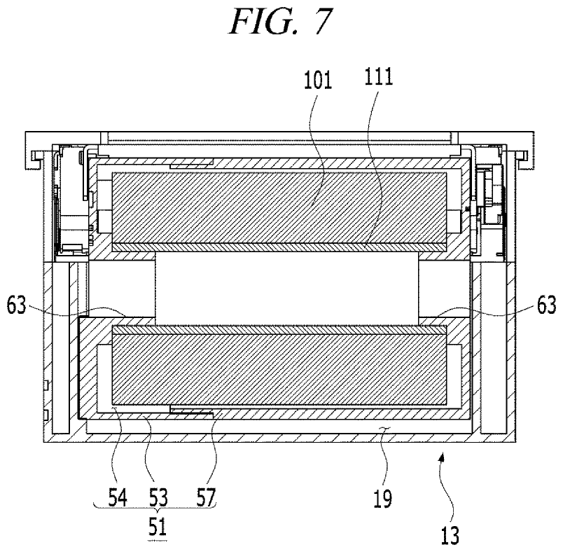

FIG. 1 to FIG. 12 illustrate a printer for repositionable note in accordance with an exemplary embodiment of the present disclosure.

As illustrated in the drawings, a printer 10 for repositionable note in accordance with an exemplary embodiment of the present disclosure includes a housing 11, a print unit 31, and a decurling unit 41.

The housing 11 has a box shape. The housing 11 is configured by combining a lower housing 13 and an upper housing 15.

The lower housing 13 has a box shape with an open top side, and the upper housing 15 is provided to cover the open top side of the lower housing 13.

The upper housing 15 may be rotatably combined with one side of the lower housing 13 by a hinge 17 and thus can open and close the top side of the lower housing 13.

In the present exemplary embodiment, it is illustrated that the lower housing 13 and the upper housing 15 are hinge-combined with each other, but may not be limited thereto. The upper housing 15 and the lower housing 13 may be separably combined with each other. That is, although not illustrated in the drawings, an elastic combination protrusion and a combination groove may be included in the lower housing 13 and the upper housing 15, respectively, and, thus, when the elastic combination protrusion is inserted into the combination groove, the lower housing 13 and the upper housing 15 may be separably combined with each other. Otherwise, the lower housing 13 and the upper housing 15 may be separably combined with each other using a separate clamping member such as a screw, a bolt, a pint, a rivet, and the like.

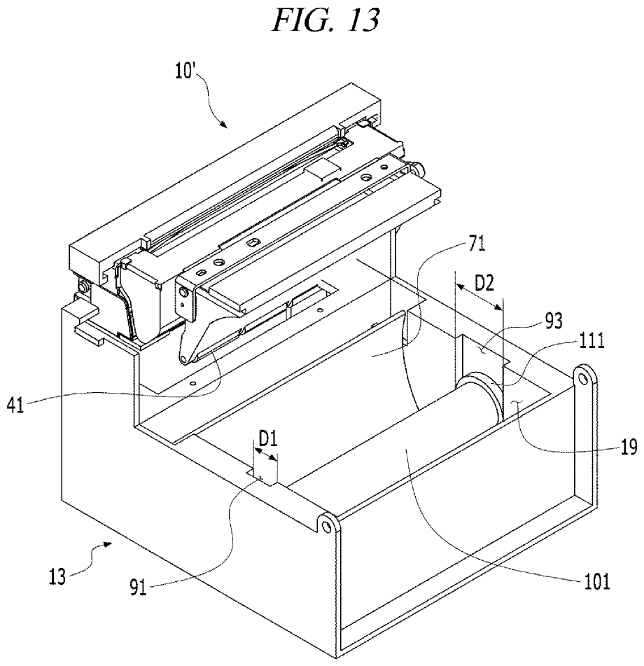

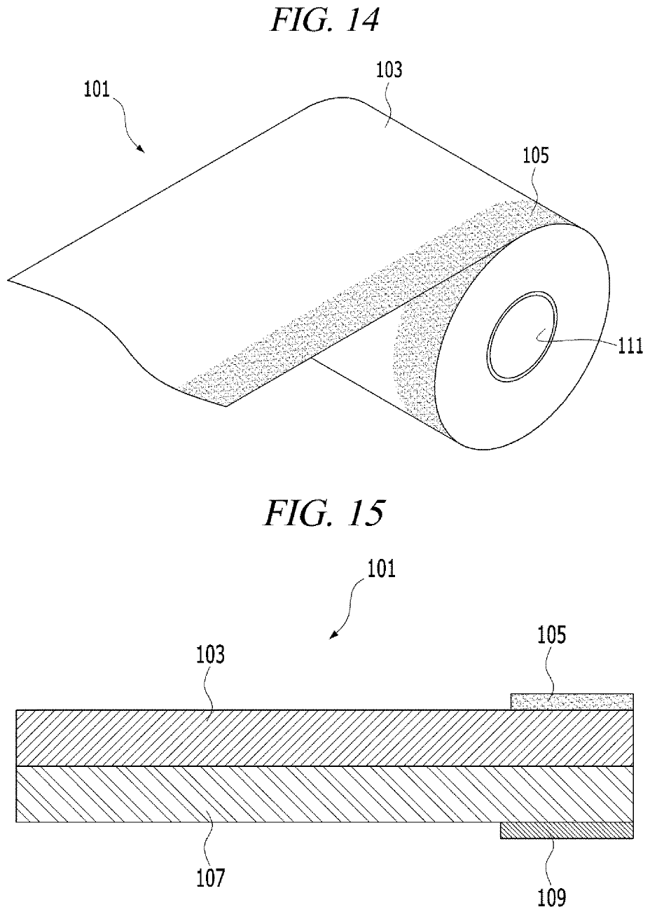

The housing 11 includes an accommodation unit 19 configured to accommodate a repositionable note 101 wound in the form of a roll with an adhesive portion 105 exposed (see FIG. 14). The accommodation unit 19 is provided within the lower housing 13 and accommodates a cartridge case 51 which is configured to accommodate the note 101 and will be described later. Herein, the accommodation unit 19 may not accommodate the cartridge case 51, and the note 101 may be rotatably mounted within the accommodation unit 19.

Meanwhile, in the present exemplary embodiment, it is illustrated that the note 101 wound in the form of a roll with the adhesive portion 105 exposed is accommodated in the accommodation unit 19, but may not be limited thereto. It is to be noted that the note 101 wound in the form of a roll with the adhesive portion 106 unexposed may be accommodated in the accommodation unit 19.

On an upper surface of the housing 11, an ejection outlet 21 through which the note 101 is ejected to the outside of the housing 11 is formed. The ejection outlet 21 may be formed at a boundary between the lower housing 13 and the upper housing 15. Specifically, the ejection outlet 21 may be formed by separating the other end opposite to one end of the upper housing 15 hinge-combined with the lower housing 13 from one end of the lower housing 13 provided adjacent to the other end of the upper housing 15.

Herein, although not illustrated in the drawings, the ejection outlet 21 may be formed on a lateral surface of the lower housing 13 unlike the present exemplary embodiment.

Further, the housing 11 includes a movement path (withdrawal path) for the 101 between the accommodation unit 19 and the ejection outlet 21.

The print unit 31 is provided on the movement path for the note 101 and configured to form, e.g., print, an image on the note 101.

The print unit 31 includes a thermal head 33 configured to print on the note ejected through the ejection outlet 21 and a feed roller 35 configured to form a print nip between the feed roller and the thermal head 33 and apply pressure to the thermal head 33 while rotating in a winding direction of the note 101.

The thermal head 33 is configured to apply heat to the note 101 passing through the print nip to form an image on the note 101. Although not illustrated in the drawings, multiple heating elements may be included in the thermal head 33, and the thermal head 33 may selectively make some of the multiple heating elements generate heat. The multiple heating elements may include multiple heating resistors, an electrode that make the heating resistors generate heat, and a protective layer configured to protect the heating resistors and the electrode.

When the thermal head 33 generate heat, the note 101 may develop a color in response thereto. For example, only a portion of the note 101 applied with heat by the thermal head 33 may turn black. To this end, the note 101 may include a thermal sensitive layer 107.

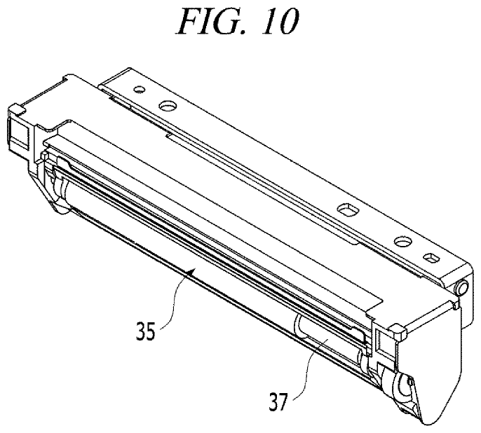

The feed roller 35 has a cylindrical shape as illustrated in FIG. 10 and is configured to transfer the note 101 and apply pressure to the thermal head 33 with the note 101 therebetween. The feed roller 35 is configured to eject the note 101 toward the ejection outlet 21 while applying pressure to the note 101. The feed roller 35 receives driving power from a transfer motor (not illustrated) and rotates around a rotation axis 39. Specifically, the feed roller 35 rotates in a direction opposite to a rotation direction of the note 101 in which the note 101 accommodated in the housing 11 is unwound. A power transfer unit (not illustrated) configured to transfer power may be provided between the feed roller 35 and the transfer motor.

Herein, although not illustrated in the drawings, a fixed part and a step may be formed on an upper end of the feed roller 35 and a low portion of the fixed part may be positioned corresponding to the adhesive portion and a high portion of the fixed part may be positioned corresponding to a non-adhesive portion.

Meanwhile, the feed roller 35 includes a stepped portion 37 on one end and is combined with the rotation axis 39. An outer periphery of the feed roller 35 positioned corresponding to a movement path for the adhesive portion 105 of the note 101 may include the stepped portion 37 having a smaller diameter than that of the other outer periphery.

Further, the print unit 31 is positioned on one side of the feed roller 35 while overlapping with the movement path for the note 101, and may include a fixed part including a step corresponding to the adhesive portion 105 and the non-adhesive portion of the note 101.

Thus, it is possible to suppress contamination of the print unit 31 by the adhesive portion 105 of the note 101 while the note 101 is printed passing between the thermal head 33 and the feed roller 35.

Herein, although not illustrated in the drawings, a rolling wheel may be provided on the outer periphery of the feed roller positioned corresponding to the movement path for the adhesive portion of the note 101 in accordance with another exemplary embodiment. The rolling wheel is not brought into pressure contact with the adhesive portion 105 of the note 101 due to a frictional force and has a small width to be in rotatably rolling contact with the adhesive portion 105 of the note 101.

Further, the thermal head 33 may be provided in the lower housing 13 and the feed roller 35 may be provided in the upper housing 15. Thus, the upper housing 15 is opened to accommodate the note 101 in the accommodation unit 19 and then, in a state where a part of the note 101 accommodated in the accommodation unit 19 is positioned on an upper side of the thermal head 33, the upper housing 15 is closed to position the note 101 between the thermal head 33 and the feed roller 35. When the upper housing 15 is closed, the feed roller 35 is brought into contact with the thermal head 33 with the note 101 therebetween, and, thus, the print nip is formed. Further, when the upper housing 15 is closed, the feed roller 35 may receive power from the transfer motor. Meanwhile, the feed roller 35 may generate curls on the repositionable note 101 passing through the feed roller 35 in a direction opposite to the winding direction of the note 101 and thus reduce curls on the note 101.

The decurling unit 41 is provided on the movement path for the note 101 between the accommodation unit 19 and the print unit 31. In the decurling unit 41, the note 101 is in sliding contact with the decurling unit 41. For example, the note 101 unwound from the housing 11 and then supplied to the print unit 31 is guided by the decurling unit 41 to be curved in the direction opposite to the rotation direction of the note 101. Thus, curls on the note 101 supplied to the print unit 31 are removed or reduced.

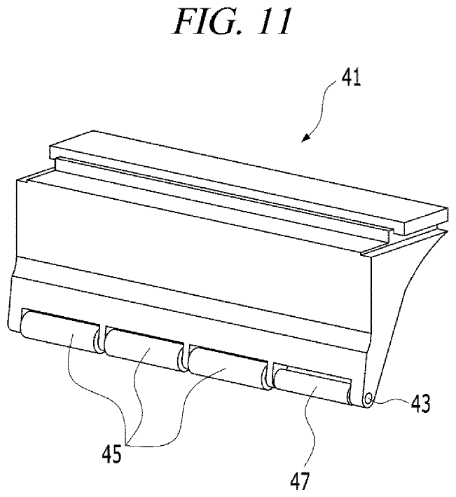

The decurling unit 41 includes multiple unit sliding bars 45 combined with a sliding bar axis 43 at a distance from each other as illustrated in FIG. 11. Each unit sliding bar 45 has a cylindrical shape, and one of the multiple unit sliding bars 45 positioned corresponding to the movement path for the adhesive portion 105 of the note 101 serves as a step sliding bar 47 having a smaller diameter than the other unit sliding bars 45. Thus, the decurling unit 41 may include a step or a rollable device at a position corresponding to the movement path of the adhesive portion 105 of the note 101.

Further, the sliding bar 45 is configured as a rotatable roller in order for the note 101 to be rollable.

Thus, while the adhesive portion 105 of the note 101 moves to the print unit 31 along the movement path, the adhesive portion 105 is not brought into contact with a surface of the decurling unit 41. Therefore, it is possible to suppress a malfunction occurring when the note 101 adheres to the decurling unit 41 so as not to be moved.

Herein, although not illustrated in the drawings, one or more rollers rotatably combined with an axis may constitute the decurling unit 41 in accordance with another exemplary embodiment. If the decurling unit 41 includes the rollers as such, the adhesive portion 105 of the note 101 passing through the decurling unit 41 may not be damaged when the rollers roll.

The flatness of the note 101 transferred to the print unit 31 is improved by the decurling unit 41, and, thus, the print quality of the printer for repositionable note in accordance with an exemplary embodiment of the present disclosure can be improved. Further, a paper jam referring to a state where the note 101 is jammed in the feed roller 35 and the ejection outlet 21 can be suppressed, and, thus, the printed note 101 can be readily ejected and the ejected note 101 being attached can be neatly kept.

Herein, it is illustrated that the decurling unit 41 in accordance with the present exemplary embodiment includes the multiple unit sliding bars 45 and the step sliding bar 47 combined with the sliding bar axis 43 at a distance from each other, but may not be limited thereto. The decurling unit 41 may have a cylindrical shape and may include a step on its outer periphery positioned corresponding to the movement path for the adhesive portion 105 of the note 101 and the step may have a smaller diameter than that of the other outer periphery of the decurling unit 41.

Further, it is illustrated that the decurling unit 41 in accordance with the present exemplary embodiment is provided on the movement path for the note 101 between the accommodation unit 19 and the print unit 31, but may not be limited thereto. The decurling unit 41 may be provided between the print unit 31 and the ejection outlet 21.

Hereinafter, the repositionable note 101 applicable to the printer 10 for repositionable note in accordance with the present disclosure will be described briefly. The repositionable note 101 applicable to the printer 10 of the present disclosure has a structure in which a base material 103 and the thermal sensitive layer 107 on which an image is printed by the printer 10 are laminated, as illustrated in FIG. 14 and FIG. 15.

The base material 103 is a basic material for combination and may be formed of various types of paper, plastics, and the like.

The adhesive portion 105 coated with an adhesive is provided on a part of the base material 103. The adhesive portion 105 is provided with a uniform width along a side, e.g., a movement direction of the note 101. The adhesive portion 105 is coated with the adhesive having an appropriate re-adhesion force, and, thus, the attached note 101 can be detached from the adhesive portion 105 and the detached note 101 can be attached to the adhesive portion 105 again. In the present exemplary embodiment, it is illustrated that the adhesive portion 105 is provided on only a part of the base material 103, but may not be limited thereto. The adhesive portion 105 may be provided on the entire base material 103.

The thermal sensitive layer 107 is formed by coating a thermal sensitizer on the entire base material 103.

A release layer 109 coated with a release agent is provided on a part of the thermal sensitive layer 107. The release layer 109 is configured to suppress adhesion between the base material 103 and the thermal sensitive layer 107 by the adhesive portion 105 in a state where the note 101 is wound in the form of a roll and enable the base material 103 and the thermal sensitive layer 107 to be easily separated from each other while the note 101 is unwound. The release layer 109 may be formed of a release agent such as silicon resin, polyvinyl alcohol, paraffin, wax, or the like.

The release layer 109 may be provided corresponding to the adhesive portion 105. For example, if the adhesive portion 105 is provided on only a part of the base material 103, the release layer 109 may be provided on only a part of the thermal sensitive layer 107. Further, if the adhesive portion 105 is provided on the entire base material 103, the release layer 109 may be provided on the entire thermal sensitive layer 107. Herein, the release layer 109 may be provided with a greater width than that of the adhesive portion 105 in consideration of an alignment error generated when the note 101 is wound in the form of a roll.

The note 101 applicable to the printer 10 of the present disclosure is provided as being wound in the form of a roll with the adhesive portion 105 exposed along the circumference of a paper roller 111.

Meanwhile, the printer 10 for repositionable note in accordance with an exemplary embodiment of the present disclosure further includes the cartridge case 51 configured to accommodate the note 101 and fix a position of the center of the note 101.

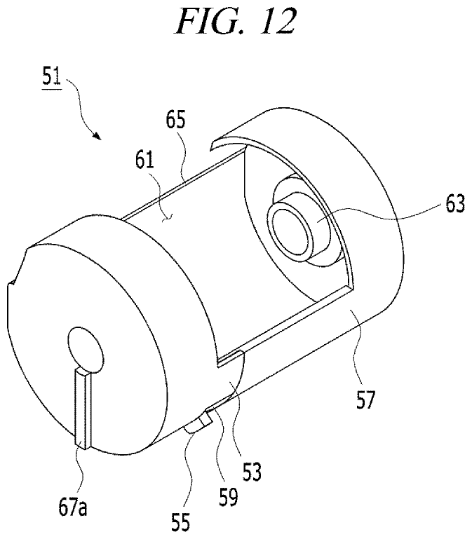

The cartridge case 51 is detachably attached to the accommodation unit 19. The cartridge case 51 includes a first cartridge case 53 and a second cartridge case 57 which are combined and can be separated from each other back and forth, as illustrated in FIG. 12.

For example, the first cartridge case 53 includes a combination protrusion 55 and the second cartridge case 57 includes a combination groove 59, and, thus, the first cartridge case 53 and the second cartridge case 57 may be separably combined with each other when the combination protrusion 55 is hook-combined with the combination groove 59. However, a method for separably combining the first cartridge case 53 and the second cartridge case 57 is not limited thereto. The first cartridge case 53 and the second cartridge case 57 may be separably combined with each other via screw combination.

The first cartridge case 53 and the second cartridge case 57 have the same outer diameter, and, thus, the first cartridge case 53 and the second cartridge case 57 are combined with each other into a cylindrical shape overall without a step. Further, in each of the first cartridge case 53 and the second cartridge case 57, a note accommodation part 61 configured to cover and accommodate the note 101 therein is formed. The note accommodation part 61 is configured to accommodate the note 101 wound in the form of a roll around the paper roller 111, and the adhesive portion 105 of the note 101 is exposed to the outside.

Meanwhile, an inner diameter of the first cartridge case 53 is greater than that of the second cartridge case 57, and, thus, the note accommodation part 61 formed by the first cartridge case 53 and the second cartridge case 57 may include a step, e.g., a spacer 54, with an increased diameter.

Further, the note 101 may be accommodated in order for the adhesive portion 105 of the note 101 to be positioned on the note accommodation part 61 of the first cartridge case 53 where the spacer 54 is formed. Thus, while the adhesive portion 105 of the note 101 is accommodated in the note accommodation part 61 and moves toward the print unit 31 along the movement path, the adhesive portion 105 is not brought into contact with an inner surface of the first cartridge case 53. Therefore, it is possible to suppress a malfunction occurring when the note 101 adheres so as not to be moved.

Herein, in the present exemplary embodiment, it is described that the inner diameter of the first cartridge case 53 is greater than that of the second cartridge case 57, but may not be limited thereto. The inner diameter of the second cartridge case 57 may be greater than that of the first cartridge case 53 and the note 101 may be accommodated in order for the adhesive portion 105 of the note 101 to be positioned on the note accommodation part 61 of the second cartridge case 57 where a step with an increased diameter is formed.

Further, each of the first cartridge case 53 and the second cartridge case 57 includes a note holder 63 configured to fix a position of the accommodated note 101 and rotatably mount the note thereon. The note holder 63 is provided on an inner surface of each of the first cartridge case 53 and the second cartridge case 57. The note holder 63 is configured to rotatably support both ends of the note paper roller 111 and form a rotation central axis for the note 101.

Specifically, the note holder 63 has a cylindrical shape and is protruded from the inner surface of each of the first cartridge case 53 and the second cartridge case 57, and the both ends of a rotation central hole of the note paper roller 111 wound around with the note 101 are rotatably mounted on the note holders 63, respectively. Herein, a shape of the note holder 63 is not limited thereto. Although not illustrated in the drawings, a cylindrical shaft may be provided at a rotation center of the note paper roller 111 and protruded to a predetermined length along a width direction of the note 101, and the note holder 63 may include a receiving groove shape by which both ends of the cylindrical shaft are rotatably received, and, thus, the note 101 may be rotatably mounted.

Therefore, the note holder 63 fixes a position of a rotation center for the note 101, and, thus, even if a radius of the wound note 101 is reduced as the note 101 is consumed, the position of the rotation center is not changed. Meanwhile, the note holder 63 that forms the rotation central axis for the note 101 may be positioned higher than a central axis of the decurling unit 41 with respect to the bottom of the housing 11.

Further, although not illustrated in the drawings, the note holders 63 on the first cartridge case 53 and the second cartridge case 57 may have different outer diameters from each other and both ends of the note paper roller 111 wound around with the note 101 may have different inner diameters. Thus, when the note paper roller 111 wound around with the note 101 is accommodated in the cartridge case 51 and mounted on each of the note holders 63, it is possible to easily distinguish an accommodation direction of the note 101 and also possible to suppress incorrect accommodation of the note 101.

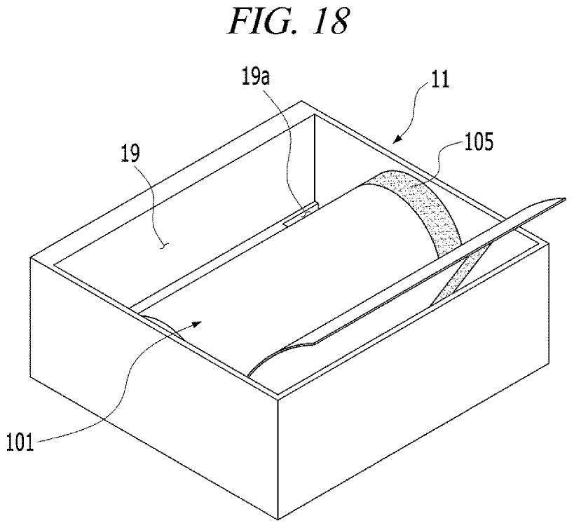

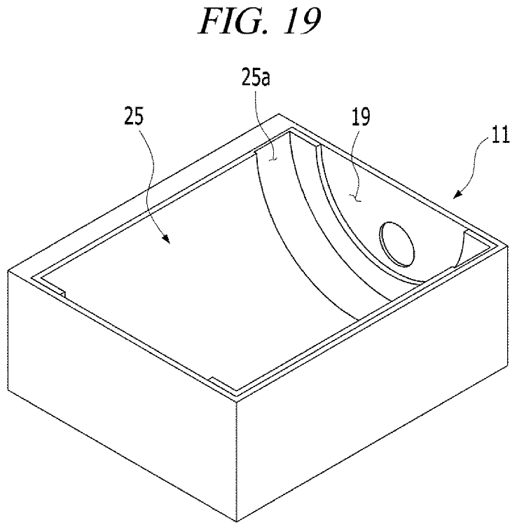

Further, in the present exemplary embodiment, it is illustrated that the repositionable note 101 is accommodated in the cartridge case 51, but may not be limited thereto. The repositionable note 101 may be directly mounted in the accommodation unit 19 of the housing 11 as illustrated in FIG. 18. In this case, the accommodation unit 19 of the housing 11 may include a step 19a at a position corresponding to the adhesive portion 105 of the repositionable note 101 as illustrated in FIG. 17, and, thus, it is possible to suppress damage caused by a contact of the adhesive portion 105 of the repositionable note 101 with an inner surface of the accommodation unit 19 of the housing 11.

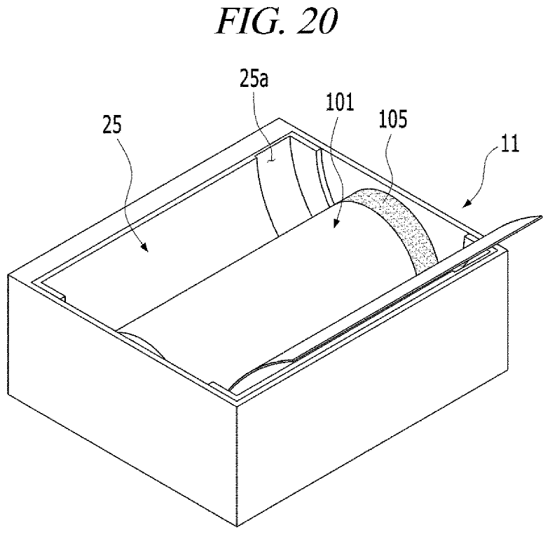

Furthermore, the repositionable note 101 may be accommodated in the note basket 25 which is detachably accommodated in the accommodation unit 19 of the housing 11 as illustrated in FIG. 20. In this case, the note basket 25 may include a step 25a at a position corresponding to the adhesive portion 105 of the repositionable note 101 as illustrated in FIG. 19, and, thus, it is possible to suppress damage caused by a contact of the adhesive portion 105 of the repositionable note 101 with an inner surface of the note basket 25.

Meanwhile, a withdrawal opening 65 for supplying the note 101 to the print unit 31 is formed on one side of the cartridge case 51. The withdrawal opening 65 is partially cut along a longitudinal direction of the cartridge case 51.

Further, the cartridge case 51 further includes an attachment and detachment means for attaching and detaching the cartridge case 51 to and from the housing 11.

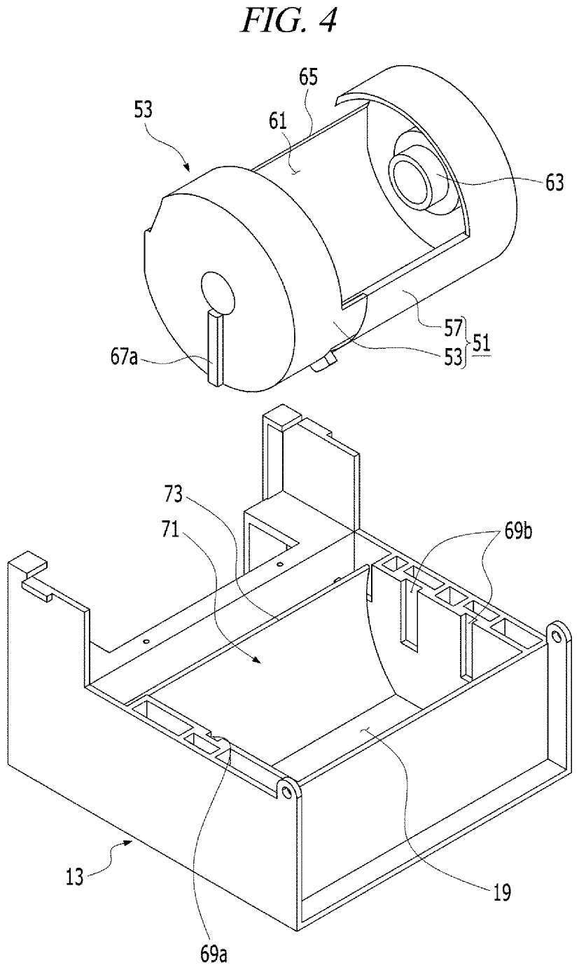

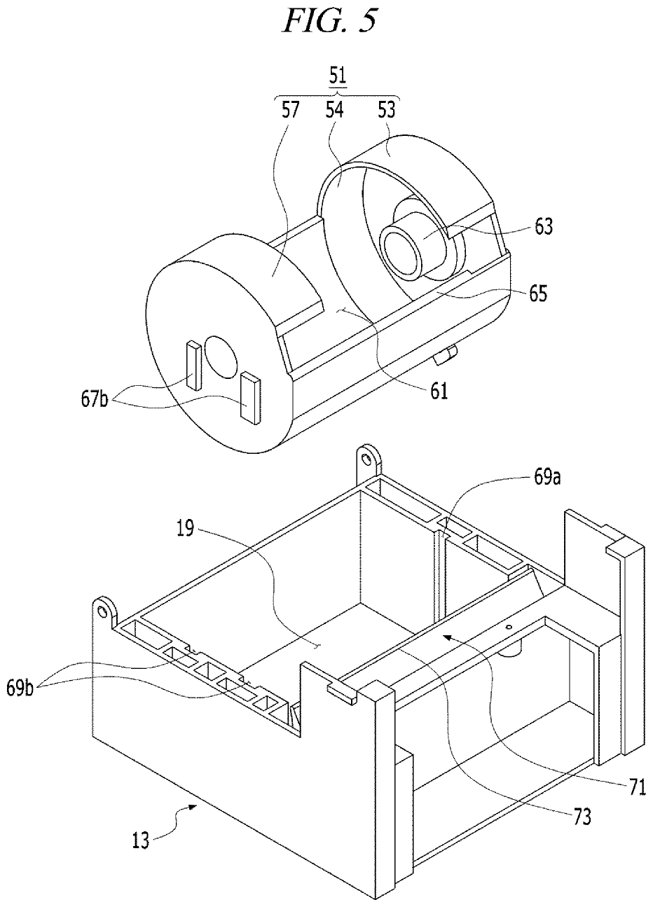

The attachment and detachment means includes protrusions 67a and 67b protruded from outer surfaces of the first cartridge case 53 and the second cartridge case 57, respectively, and insertion grooves 69a and 69b which are dented in the inner surface of the accommodation unit 19 of the housing 11 and into which the protrusions 67a and 67b are inserted and combined, as illustrated in FIG. 4 and FIG. 5.

A first protrusion 67a having a square pillar shape is protrude to a predetermined length from the outer surface of the first cartridge case 53, and two second protrusions 67b are protruded to predetermined length from the outer surface of the second cartridge case 57.

Accordingly, the insertion grooves 69a and 69b are dented in the inner surface of the accommodation unit 19 of the housing 11 at positions corresponding to the protrusions 67a and 67b of the first cartridge case 53 and the second cartridge case 57, respectively. The insertion grooves 69a and 69b have shapes corresponding to cross-sections of the protrusions 67a and 67b, respectively. However, shapes of the protrusions 67a and 67b and the insertion grooves 69a and 69b are not limited thereto, and the protrusions 67a and 67b and the insertion grooves 69a and 69b may have various cross-sections.

Therefore, the cartridge case 51 may be mounted and fixed in the accommodation unit 19 of the housing 11. Further, since the protrusions 67a and 67b protruded from the first cartridge case 53 and the second cartridge case 57, respectively, are different from each other in number, when the cartridge case 51 is mounted in the accommodation unit 19 of the housing 11, it is possible to easily distinguish an accommodation direction of the cartridge case 51 and also possible to suppress incorrect mounting of the cartridge case 51. Therefore, it is possible to suppress incorrect accommodation of the note 101 in the accommodation unit 19 of the housing 11.

Herein, in the present exemplary embodiment, it is illustrated that as an attachment and detachment means, the protrusions 67a and 67b are protruded from the first cartridge case 53 and the second cartridge case 57 and the insertion grooves 69a and 69b are dented in the inner surface of the accommodation unit 19 of the housing 11, but may not be limited thereto. The protrusions 67a and 67b may be protruded from the inner surface of the accommodation unit 19 of the housing 11 and the insertion grooves 69a and 69b may be dented in the first cartridge case 53 and the second cartridge case 57 to attach and detach the cartridge case 51 to and from the housing 11.

Further, in the present exemplary embodiment, it is illustrated that the cartridge case 51 has a cylindrical shape with the same outer diameter, but may not be limited thereto. The cartridge case 51 may include a step having a different outer diameter, and accordingly, a step may be formed on the accommodation unit 19 of the housing 11 by making a difference in inner diameter of the accommodation unit 19 of the housing 11. Therefore, when the cartridge case 51 is mounted in the accommodation unit 19 of the housing 11, the steps on the cartridge case 51 and the accommodation unit 19 of the housing 11 can make it possible to easily distinguish an accommodation direction of the cartridge case 51 and also possible to suppress incorrect mounting of the cartridge case 51.

Further, although not illustrated in the drawings, the cartridge case 51 may be formed asymmetrically in a front to back direction or in an up and down direction, and accordingly, the accommodation unit 19 of the housing 11 may be formed asymmetrically. Thus, it is possible to suppress incorrect mounting of the cartridge case 51 in the accommodation unit 19 of the housing 11.

Meanwhile, the printer 10 for repositionable note in accordance with an exemplary embodiment of the present disclosure further includes a droop suppressing guide 71 provided on the movement path and configured to suppress the droop of the note 101 moving to the decurling unit 41.

The droop suppressing guide 71 is provided in the housing 11 and forms a part of the movement path for the note 101 and is curved to partially surround the decurling unit 41. Since the droop suppressing guide 71 is formed to partially surround the decurling unit 41, the note 101 moving along the movement path between the droop suppressing guide 71 and the decurling unit 41 does not droop due to the decurling unit 41 and is applied with tension by the decurling unit 41.

The note 101 is slidably moved on a front end 73 of the droop suppressing guide 71.

The front end 73 of the droop suppressing guide 71 is round-shaped and positioned equal to or higher than the rotation central axis for the note 101 with respect to the bottom of the housing 11.

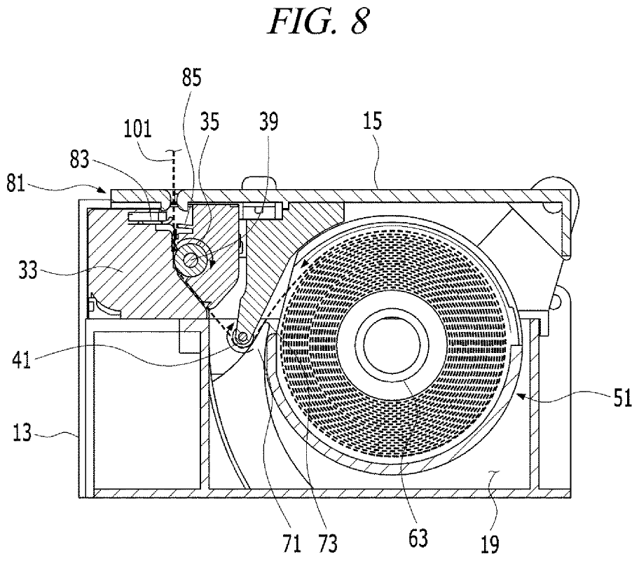

That is, since the printer 10 for repositionable note in accordance with an exemplary embodiment of the present disclosure has a structure in which the note 101 configured to move to the decurling unit 41 as being wound around the cartridge case 51 as illustrated in FIG. 8 moves from an upper side toward a lower side of the housing 11, if the front end 73 of the droop suppressing guide 71 is positioned lower than the height of the rotation central axis for the note 101 with respect to the bottom of the housing 11, the note 101 accommodated in the cartridge case 51 is consumed. Thus, a radius of rotation of the wound note 101 is reduced and the note 101 positioned between the decurling unit 41 and the withdrawal opening 65 of the cartridge case 51 may become loose and then droop. Thus, the note 101 supplied to the decurling unit 41 may be likely to be overlapped and decurled. Further, there may be a problem with the movement of the note 101 to the print unit 31 and the print quality may deteriorate.

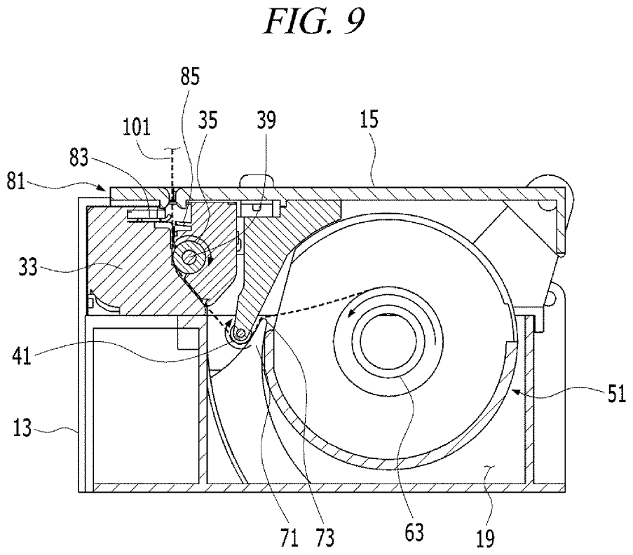

Therefore, the droop suppressing guide 71 is provided between the decurling unit 41 and the cartridge case 51 and the front end 73 of the droop suppressing guide 71 is positioned equal to or higher than the rotation central axis for the note 101 with respect to the bottom of the housing 11. Thus, even if the note 101 accommodated in the cartridge case 51 as illustrated in FIG. 9 is consumed and the radius of rotation of the wound note 101 is reduced, the note 101 positioned between the decurling unit 41 and the withdrawal opening 65 of the cartridge case 51 does not droop due to the droop suppressing guide 71. Thus, it is possible to suppress the problem with the movement of the note 101 to the print unit 31 and deterioration of the print quality.

Herein, in the present exemplary embodiment, it is illustrated that the droop suppressing guide 71 is provided in the housing 11, but may not be limited thereto. The droop suppressing guide 71 may be provided in the cartridge case 51 to be adjacent to the withdrawal opening 65 of the cartridge case 51.

Further, the printer 10 for repositionable note in accordance with an exemplary embodiment of the present disclosure may further include a cutting unit 81.

The cutting unit 81 may include a fixed knife 83 and a moving knife 85 configured to cut the note 101 by being close to and separated from the fixed knife 83 by driving power from the motor (not illustrated), as illustrated in FIG. 8.

Therefore, the continuous note 101 passing through the print unit 31 may be cut into a unit note 101 by the cutting unit 81. The unit note 101 may be ejected to the outside of the printer 10 through the ejection outlet 21.

By this configuration, in the printer 10 for repositionable note in accordance with an exemplary embodiment of the present disclosure, the note 101 wound in the form of a roll with the adhesive portion 105 exposed as illustrated in FIG. 8 is withdrawn from the cartridge case 51 and passes through the droop suppressing guide 71 and is supplied to the print unit 31 while curved curls on the note 101 are reduced or uncurled by the decurling unit 41, and then note 101 is printed with an image through the thermal head 33 of the print unit 31 and then ejected through the ejection outlet 21.

Meanwhile, the note 101 withdrawn from the cartridge case 51 is supplied to the decurling unit 41 without being loosened due to the droop suppressing guide 71, and the decurling unit 41 removes or reduces curls on the note 101 supplied to the print unit 31 and thus improves the flatness of the note 101. Therefore, the print quality can be improved and a paper jam referring to a state where the note 101 is jammed on the movement path can be suppressed. Further, the printed note 101 can be readily ejected and the ejected note 101 being attached can be neatly kept.

Meanwhile, it is illustrated that in the printer 10 for repositionable note in accordance with an exemplary embodiment of the present disclosure, the note 101 wound in the form of a roll around the note paper roller 111 with at least one adhesive portion 105 exposed is supplied to the print unit 31 as being accommodated in the cartridge case 51, but may not be limited thereto. In the printer 10 for repositionable note in accordance with an exemplary embodiment of the present disclosure, the note 101 wound in the form of a roll around the note paper roller 111 may directly mounted in the accommodation unit 19 of the housing 11 without being accommodated in the cartridge case 51.

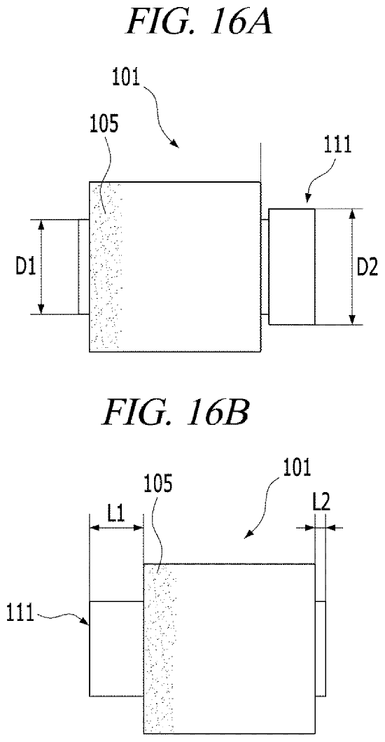

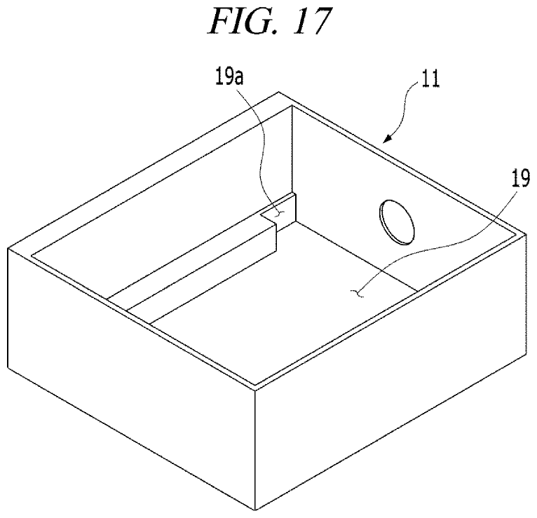

If the repositionable note 101 wound in the form of a roll around the note paper roller 111 is directly mounted in the accommodation unit 19 of the housing 11 as such, both ends of the note paper roller 111 may have different outer diameters D1 and D2 from each other as illustrated in FIG. 16A and a first mounting groove 91 and a second mounting groove 93 having inner diameters corresponding to the outer diameters of the both ends of the note paper roller 111, respectively, may be formed in the inner surface of the housing 11 as illustrated in FIG. 13. For example, an inner diameter of the first mounting groove 91 may be smaller than that of the second mounting groove 93. The note paper roller 111 wound around with the note 101 may be rotatably mounted in the first mounting groove 91 and the second mounting groove 93.

The mounting grooves 91 and 93 are respectively dented in the form of long holes with widths corresponding to the outer diameters D1 and D2 of the both ends of the note paper roller 111 to a predetermined depth from the upper surface of the housing 11, and the note paper roller 111 mounted in the mounting grooves 91 and 93 may rotate while forming the rotation central axis for the note 101 at a position higher than the central axis of the sliding bars 45 and 47 of the decurling unit 41 with respect to the bottom of the housing 11.

Since the both ends of the paper roller 111 have different outer diameters from each other and the first mounting groove 91 and the second mounting groove 93 respectively corresponding to the outer diameters of the both ends of the paper roller 111 are formed in the inner surface of the housing 11, it is possible to suppress incorrect accommodation of the note 101 wound in the form of a roll in the accommodation unit 19 of the housing 11.

Further, in another exemplary embodiment, the both ends of the paper roller 111 wound around with the note 101 in the form of a roll as illustrated in FIG. 16B may be protruded to different lengths L1 and L2, respectively. Thus, it is possible to suppress incorrect accommodation of the note 101 wound around the paper roller 111 in the form of a roll in the accommodation unit 19 of the housing 11.

Although the exemplary embodiments of the present disclosure have been described in detail with reference to the accompanying drawings, it would be understood by those skilled in the art that various changes and modifications may be made without changing technical conception and essential features of the present disclosure. Thus, it is clear that the above-described embodiments are illustrative in all aspects and do not limit the present disclosure.

What is claimed is:

1. A printer for a repositionable note, comprising:
a housing including an accommodation unit configured to accommodate a repositionable note wound in a form of a roll with at least one adhesive portion exposed and an ejection outlet through which the note withdrawn from the accommodation unit is ejected, and forming a movement path for the note from the accommodation unit to the ejection outlet; and
a print unit including a thermal head provided on the movement path and configured to print on the note ejected through the ejection outlet and a feed roller configured to rotate in a direction opposite to a rotation direction of the note when the note accommodated in the housing is withdrawn and provided to face the thermal head and thus to enable printing on the note while transferring the note.

2. The printer for repositionable note of claim 1,
wherein both ends of a paper roller wound around with the note in the form of a roll have different outer diameters from each other, the accommodation unit may include a first mounting groove and a second mounting groove having inner diameters corresponding to the both ends of the paper roller having different outer diameters from each other, and the paper roller having different outer diameters is rotatably mounted in the first mounting groove and the second mounting groove.

3. The printer for repositionable note of claim 1,
wherein both ends of a paper roller wound around with the note in the form of a roll are protruded to different lengths from each other.

4. The printer for repositionable note of claim 1,
wherein both ends of a paper roller wound around with the note in the form of a roll have different inner diameters from each other.
